(19) United States
(12) Patent Application Publication
(10) Pub. No.: US 2011/0223491 A1
(43) Pub. Date: Sep. 15, 2011

(54) LITHIUM TITANATE COMPOSITE MATERIAL, PREPARATION METHOD THEREOF, NEGATIVE ACTIVE SUBSTANCE AND LITHIUM ION SECONDARY BATTERY CONTAINING THE SAME

(75) Inventors: Chaqing Xu, Shenzhen (CN); Zhanfeng Jiang, Shenzhen (CN); Lianchi Jiang, Shenzhen (CN); Hongyan Li, Shenzhen (CN); Yunbo Ye, Shenzhen (CN)

(73) Assignee: BYD Co. Ltd, Shenzhen (CN)

(21) Appl. No.: 13/128,573

(22) PCT Filed: Dec. 22, 2009
(86) PCT No.: PCT/CN09/75825

§ 371 Date: May 10, 2011

(30) Foreign Application Priority Data
Dec. 24, 2008 (CN) 200810188167.X

(51) Int. Cl. H01M 10/02; H01M 4/485; C01G 23/04; B32B 5/16; B82Y 99/00

(52) U.S. Cl. 429/338; 252/182.1; 429/231.1; 429/199; 429/342; 423/598; 428/402; 977/811

(57) ABSTRACT

Provided is a composite material having spinel structured lithium titanate, wherein the lithium titanate has a microcrystalline grain diameter of about 36-43 nm and an average particle diameter of about 1-3 μm. The composite material comprises a small amount of TiO₂ and Li₂—TiO₃ impurity phases. Also provided is a method for preparing the composite material, which comprises the steps: mixing titanium dioxide particles and soluble lithium sources with water to form a mixture, removing water and then sintering the mixture in an inert gas at a constant temperature, and cooling the sintered mixture, wherein the titanium dioxide particles have D₅₀ of not greater than 0.4 μm and D₉₅ of less than 1 μm. Further provided are a negative active substance comprising the composite material and a lithium ion secondary battery containing the negative active substance.

### CROSS REFERENCE TO RELATED APPLICATION

This application claims priority to Chinese Patent Application No. 200810188167.X, filed on Dec. 24, 2008, the entirety of which is hereby incorporated by reference.

### FIELD OF THE INVENTION

The present invention relates to electrode material, more particularly to a lithium titanate composite material and a method of preparing the same.

### BACKGROUND OF THE INVENTION

In 1996, K. Zaghib, Canada firstly disclosed that lithium titanium oxide may be used as negative electrode material. After that, researchers began to focus on researching lithium titanium oxide negative electrodes. Lithium titanate (Li₄Ti₅O₁₂) is a kind of material that have many advantages such as follows: it is uneasy to form a SEI film, the crystal lattice is uneasy to change, the potential is flat, it is environmentally amicable, and it may be normally used within a temperature range from −50 to 75° C., etc. Therefore, it is one of the preferable materials in power batteries. And it is known that replacing carbon material with lithium titanate may eliminate the hidden safety problems and improve the recycling performance and rapid charging and discharging performance.

Presently, there are various methods for preparing the lithium titanate, such as a solid phase reacting method or a sol-gel method. In the solid phase reacting method, the raw material is milled with high energy to crash it, and to disperse it uniformly. Thus, the reaction is carried out thoroughly to meet granularity requirements.

For example, Chinese Patent CN101000960A discloses a method of preparing lithium titanate electrode material comprising the following steps: 1. mixing 27.5-24.75 wt % of inorganic lithium salt, 72.5-65.25 wt % titanium dioxide and 1-10 wt % nano-carbon coating material or 0-10 wt % doping modifier (0 not included) by stirring with high speed or ball milling for 2-40 hours to prepare a precursor mixture for the lithium titanate composite; 2. dispersing the above mentioned mixture into organic solvent such as ethanol, acetone and so on, obtaining dispersed powder by transient drying; 3. treating the dispersed powder with heat treatment at 500° C.-950° C. for 4-40 hours; 4. cooling the obtained product naturally under 150° C. and then grinding and sifting the cooled product. Normally, this method employs organic carbon source or nano-carbon coating in addition to the requirement of organic solvent as well as ball milling with high energy.

Chinese Patent CN101172646A discloses a method of preparing spinel lithium titanate, in which titanium sulfate, titanyl sulfate, titanium tetrachloride, titanium trichloride and industrial intermediate of ilmenite sulfuric acid method for preparing titanium white are used as titanium source, lithium carbonate or lithium hydroxide is used as lithium source, and citric acid, tartaric acid, oxalic acid, gluconic acid, ascorbic acid, sulfosalicylic acid or the ammonium salt thereof is used as complexant. And the detailed steps are as follows: the titanium source water solution is adjusted by analytically pure ammonia until TiO₂.nH₂O is completely precipitated; the reacted solution is then filtrated rapidly and the precipitate is washed to remove anions by deionized water; the precipitate is transferred into the reaction container; the precipitate is dispersed by suitable quantity of deionized water; one or more of above mentioned complexant(s) is and/or are added into the reaction container according to the weight ratio of complexant:TiO₂=1-4:1; lithium source composition is added according to the atomic ratio of Li:Ti=0.8-0.84:1, and the mixture solution is adjusted by analytically pure ammonia until pH=4.0-9.0; and then the solution system is stirred and boiled under a temperature of 50° C.-100° C., the pH of the system remains stable at about 5-7 along with the evaporation of water and ammonia, and gradually turns into gel; finally the gel is dried under a temperature of 100-200° C., obtaining buff dried gel, which is placed in a porcelain boat and put into a tube furnace; the material is reacted for 1-8 hours under 450-850° C. with the temperature rising at a speed of about 5-20° C./min in air atmosphere, and the reaction product is taken out to obtain white loose Li₄Ti₅O₁₂ powder product. Conventionally, organic complexant is used in the sol-gel method, and the usual requirement of using titanium and lithium organics as precursors may result in relatively high cost and lower yield. Thus, it is not advantageous for mass production.

Chinese Patent CN1893166A discloses a non-aqueous electrolyte battery comprising a positive electrode, a negative electrode, and non-aqueous electrolyte. The negative electrode comprises porous powder with an average pore diameter of 50-500 Å of lithium titanium composite oxide. The preparation method of the lithium titanium composite oxide according to an embodiment is: the lithium salt is dissolved into pure water, and the titanium dioxide is added into the solution thus formed to adjust the atomic ratio of lithium to titanium to the predetermined ratio. Then the solution is stirred and dried to obtain a precursor for sintering. The obtained precursor is sintered, obtaining the lithium titanium composite oxide. Then, the lithium titanium composite oxide is powdered and re-sintered. This method can achieve a precursor with uniform granularity. However, the product according to the above method may have multiple impurity phases with a heavy amount of impurities. Besides, it requires regranulating and drying as well as further powdering and sintering. These involve complicated processes with poor reproducibility. Thus, it is not beneficial for industrialization.

In all, the battery containing spinel structured lithium titanium composite material prepared according to the prior art can not have high initial specific discharge capacity with excellent rate discharge property. And the performance of the batteries manufactured therefrom may not meet the growing requirements of the battery development.

### SUMMARY OF THE INVENTION

In view of the foregoing, there remains an opportunity to provide a lithium titanate composite material and a method of preparing the same, in which the lithium titanate composite material is modified to exhibit excellent initial specific discharge capacity while maintaining excellent rate discharge property. There is also an opportunity to provide a negative active substance and a lithium-based battery that include the lithium titanate composite material.

According to an embodiment of the invention, a composite material having spinel structured lithium titanate may be provided in which a microcrystalline grain of the lithium titanate may have a diameter of about 36-43 nm and the lithium titanate may have an average particle diameter of about 1-3 um.

According to another embodiment of the invention, a negative active substance may be provided in which the composite material as mentioned above may be included.

According to still another embodiment of the invention, a lithium ion secondary battery is provided, which comprises a positive electrode; a negative electrode including the active substance as mentioned above; and a non-aqueous electrolyte.

According to yet another embodiment of the invention, a method of preparing a composite material having spinel structured lithium titanate is provided, which may comprise the following steps: mixing titanium dioxide particles and soluble lithium sources with water; removing water and then sintering the mixture in inert gas under a predetermined constant temperature; and cooling the sintered mixture, the titanium dioxide particles have D₅₀ not greater than 0.4 um and D₉₅ less than 1 um.

According to the present invention, the composite material has both high initial specific discharge capacity and outstanding high-rate discharge property.

According to the method of the present invention, by mixing titanium dioxide powder of certain particle size and soluble lithium source with water and then after removing the water, the surface of the titanium dioxide powder may be enveloped by the lithium source to form uniform precursor so that the raw material may be uniformly mixed. Meanwhile, the inventor found by chance that, the lithium titanate composite material according to the present invention has a small number of impurity phases. The amounts of the TiO₂ and the Li₂TiO₃ are measured by XRD. With the main peak intensity of the spinel lithium titanate oxide being assumed as 1, the main peak intensity of TiO₂ is lower than 1.0%, and the main peak intensity of Li₂TiO₃ is lower than 2.25%. Besides, in the present invention, the dissolved lithium source in the water may be precipitated on the surface of the lithium dioxide particles uniformly during the process of removing water, so that the lithium dioxide particle is uneasy to grow. At the same time, the raw materials are dispersed uniformly, achieving a very good uniformly dispersed system. The lithium titanate thus prepared has outstanding electrochemical properties, especially to the lithium titanate composite material having microcrystalline grain with a diameter of about 36-43 nm and an average particle diameter of 1-3 um. The method thereof is also simple and easy for industrialization.

### DETAILED DESCRIPTION OF THE DRAWINGS

Other advantages of the present invention will be readily appreciated, as the same becomes better understood by reference to the following detailed description when considered in connection with the accompanying drawings, in which:

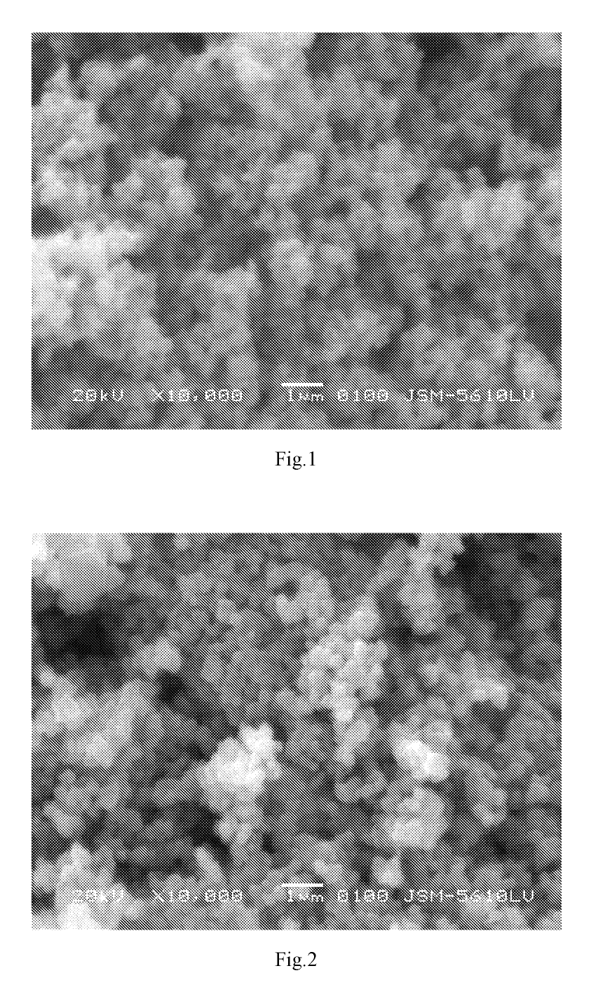

FIG. 1 shows a SEM view of a titanium dioxide amplified by 10000 times used in a method for preparing lithium titanate according to an embodiment of the present invention;

FIG. 2 shows a SEM view of a precursor material after removing water obtained by a method according to an embodiment of the present invention;

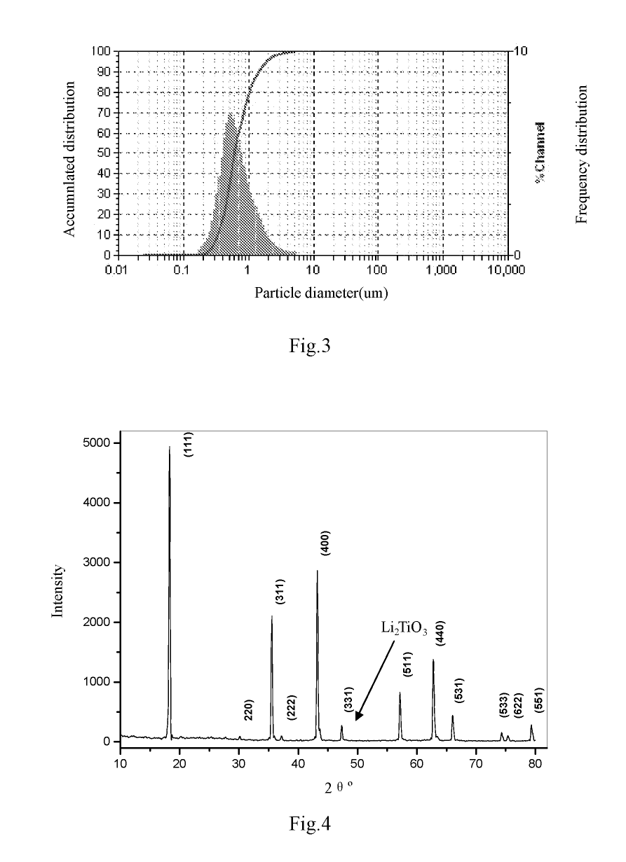

FIG. 3 shows a granularity distribution view of a precursor raw material after removing water by a method according to an embodiment of the present invention;

FIG. 4 shows an XRD view of a lithium titanate composite material according to an embodiment of the present invention;

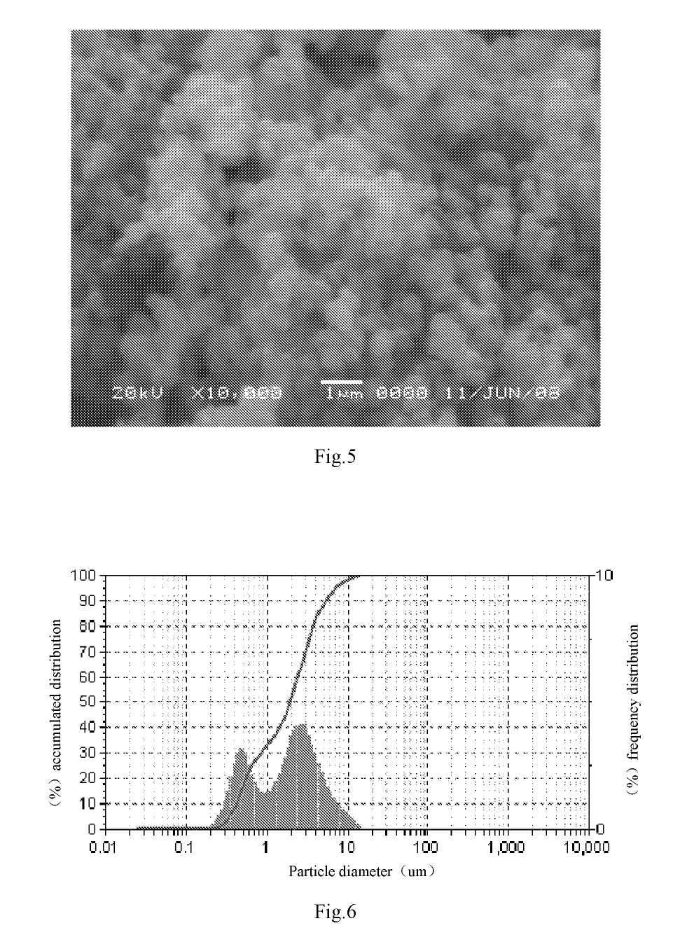

FIG. 5 shows an SEM view of a lithium titanate composite material, amplified by 10000 times, according to an embodiment of the present invention; and

FIG. 6 shows a granularity distribution view of a lithium titanate composite material according to an embodiment of the present invention.

### DETAILED DESCRIPTION OF THE PREFERRED EMBODIMENTS

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

Through experimentation, the inventor found that if the lithium titanate microcrystalline grains are too small, for which a possible explanation is that the material is not fully reacted, many impurities will be remained in the product which has a disadvantage on the intercalation and de-intercalation of the lithium ions. If the lithium titanate microcrystalline grains are too large, the diffusion distance of the lithium ions in the grains is large which results in a disadvantage on the fast charging and discharging of the lithium ions and further affect the conductivity and rate charging and discharging properties of the material.

Besides, if the average grain diameter of lithium titanate is too small, too much non-conductive substance is needed in the preparation process, and effective volume capacity of the material is limited, which is not beneficial for the preparation of the electrode plates. If the average grain diameter of lithium titanate is too large, the contact between the material and the electrolyte is weakening Meanwhile, the diffusion of the lithium ions is restricted accordingly. Thus, the inventive concepts of the present invention are proposed.

According to an embodiment of the present invention, the composite material having spinel structured lithium titanate may comprise lithium titanate. The microcrystalline grain of the lithium titanate material may have a diameter of about 36-43 nm. According to an embodiment of the invention, it may be about 38-41 nm The average diameter of the lithium titanate may be about 1-3 um. According to an embodiment of the invention, it may be about 1.2-1.8 um.

According to the present invention, the calculation method of the diameter of the microcrystalline is known in the art. For example, by calculating full width at half maximum of 0.198 of XRD in the crystal face (111) having a diffraction angle (2θ) of 18.288°, the diameter of the microcrystalline may be calculated by the following Scherrer formula.

Dₕₖ₁=(k·λ)/(β·cos θ)

in which Dₕₖ₁ means the diameter of the microcrystalline (Å, 1 Å=0.1 nm), λ means the wavelength (Å) of the X ray for measuring, β means the mid-high widening of the diffraction, θ means the Prague angle; and k is a Scherrer constant (0.9).

According to the present invention, according to an embodiment of the invention, the spinel lithium titanate composite material may further comprise carbon. Based on the total weight of the lithium titanate composite material, the content of the lithium titanate may be about 85-99 wt %. According to an embodiment of the invention, it may be about 92-97 wt %, and the content of the carbon may be about 1-15 wt %. According to an embodiment of the invention, it is about 3-8 wt %. The addition of carbon can ensure that a part of the carbon material may be inserted into or tightly coated onto the lithium titanate composite material, which effectively enhances the conductivity and high current rate performance. As the diameter of the carbon source is relatively small, it may have very limited effect on the diameter of the lithium titanate composite material.

According to an embodiment of the invention, a method of preparing a composite material having spinel structured lithium titanate may be provided. The method may comprise mixing titanium dioxide particles and soluble lithium sources with water; removing water and then sintering the mixture in inert gas under a predetermined constant temperature; cooling the sintered product to obtain titanium dioxide particles with D₅₀ not greater than 0.4 um and D₉₅ less than 1 um. According to an embodiment of the invention, the titanium dioxide particles may have D₅₀ of about 0.1-03 um and D₉₅ of about 0.6-0.9 um.

According to the present invention, a molar ratio of soluble lithium source to the titanium dioxide is about 0.95-1.1:1.25. According to an embodiment of the invention, it may be about 0.98-1.05:1.25.

According to the present invention, a weight ratio of soluble lithium source to water may be adjusted within a relatively wide range, and to ensure that the titanium dioxide is fully coated by soluble lithium source, the weight ratio of soluble lithium source to water is about 1:1-15.

According to the present invention, the method may further comprise a step of mixing the carbon source with the solution of titanium dioxide particles, soluble lithium source and water. According to the present invention, the dosage of the carbon source may be adjusted within a wide range. According to an embodiment of the invention, the carbon source is added into the lithium titanate composite material with such a dosage that, based on the total weight of the lithium titanate composite material, the content of carbon is about 1-15 wt %. According to an embodiment of the invention, it may be about 3-8 wt %. The testing method of carbon content in lithium titanate composite material may be any regular method known in the art. For example, IR carbon-sulfur spectrometer may be employed accordingly.

According to the present invention, the carbon source may be water soluble and/or non-soluble composition. The water soluble composition may be one or more selected from carbohydrate, cellulose-based polymers and polyvinyl alcohol. The water non-soluble composition may comprise one or more selected from benzene-naphthalene-phenanthrene tri-copolymer, benzene-phenanthrene bipolymer, benzene-anthracene biopolymer, phenolic resin, furfural resin, artificial graphite, nature graphite, superconducting acetylene black, acetylene black, carbon black and carbonaceous mesophase sphere. The cellulose-based polymers may be any conventional cellulose-based polymers. According to an embodiment of the invention, it may be one or more selected from methyl cellulose, ethyl cellulose, carboxymethyl cellulose and hydroxypropyl methylcellulose. The carbohydrate may be any carbohydrate, for example, it may be one or more selected from monosaccharide, disaccharide and amylose. The monosaccharide may be glucose, the disaccharide may be saccharose, the amylose may be amylum and so on.

According to the present invention, while titanium dioxide particles, soluble lithium source and water are mixed, the water soluble carbon source is added, which can ensure the water soluble carbon source and lithium salt are precipitated together on the surface of the lithium dioxide particles uniformly during the process of removing water, which ensures that organic carbon source is uniformly dispersed into the raw material in the following mixing process of the battery preparation, further ensuring pyrolysis carbon obtained may be dispersed uniformly and sized finely, as well as bonded closely with the product. Meanwhile, a part of the pyrolyzed carbon is contained within the particles which may enhance the electrical performance greatly. If it is non-soluble carbon source, according to an embodiment of the invention, the D₉₅ of the water non-soluble composition particles is less than 1 um. According to an embodiment of the invention, it may be 0.1-0.5 um, so that the carbon source may be dissolved in the water and mixed with titanium dioxide particles uniformly to effectively decrease the resistance of the negative electrode material. The lithium source may be various kinds of water soluble lithium organic salt, inorganic salt or lithium hydroxide. For example, the lithium inorganic salt may be lithium nitrite; the lithium organic salt may be lithium oxalate, lithium acetate; the hydroxide of lithium may be lithium hydroxide, lithium hydroxide hydrate. According to an embodiment of the invention, the lithium source may be one or more selected from lithium hydroxide, lithium acetate, lithium oxalate and lithium nitrite. Water soluble lithium source is employed in the present invention, thus there is no requirement on granularity, avoiding a step of crashing or ball-milling treatment.

The method of mixing the titanium dioxide particles, soluble lithium source, and optionally added carbon source with water may be any conventional methods, for example, stirring. Also the above mentioned mixing method may be carried out simultaneously or in divided steps. According to an embodiment of the invention, for better adhesion of the lithium salt onto the titanium dioxide particles, the soluble lithium source may be mixed firstly with water to obtain lithium source solutions, and then the solution may be mixed with titanium dioxide particles and optional carbon source.

The method of removing water may be any conventional method, for example, evaporating, drying and so on with a drying temperature of about 100-160° C.

The sintering conditions may comprise the temperature of about 700-1000° C. According to an embodiment of the invention, it may be about 850-900° C. The time for sintering may be about 5-48 hours. According to an embodiment of the invention, it may be 12-24 hours.

The inert gas may be a substance that does not react with the reaction of the present invention, for example, it may be one or more selected from carbon oxide, carbon dioxide, N₂ and the zero group element in the periodic table of the elements.

The present invention will be understood more clearly in conjunction with the following embodiments.

The carbon contents of the lithium titanate composite material prepared in the following examples 1-7 are tested by IR carbon-sulfur spectrometer manufactured by Yingzhicheng Company, Wuxi City, Jiangsu Province. The steps of the testing method are as follows: adding 0.03-0.5 g sample into the crucible, and then adding 0.6-0.7 g pure Fe co-solvent, 1.8-1.9 g W as combustion-supporting agent; putting the crucible into high frequency surrounding (18 MHz) to initiate the combustion reaction which uses O₂ as combustion supporting agent and carrier gas; bringing the CO₂ formed after combustion into carbon analysis pool; and the carbon content in the lithium titanate composite material is tested by the equipment as mentioned above.

### Example 1

The present example relates to the preparation of the lithium titanate composite material according to the present invention.

21.6 g LiOH.H₂O is dissolved into 180 g deionized water and 9.7 g glucose is added into solution thus formed. After the glucose is completely dissolved, anatase-type ultrafine TiO₂ having D₅₀ of 0.7 um and D₉₅ of 0.7 um with weight of 47.9 g is added into the solution under the condition of stirring (FIG. 1 shows the SEM drawing of the ultrafine TiO₂). The solution is stirred for another 30 minutes and dried under 120° C., and a precursor is obtained after removing water. The precursor is sintered for 20 hours under a temperature of 800° C. in N₂ atmosphere and naturally cooled to room temperature to obtain lithium titanate composite material M1 enveloped with carbon. Based on the total amount of the lithium titanate composite material, the carbon content is 5.4 wt %.

FIG. 2 shows a SEM view of the lithium titanate precursor after removing water by using the SSX-550 SEM equipment manufactured by Shimadzu company, Japan. From the figure, it may be concluded that the precursor has fine grains and uniform granularity distribution.

FIG. 3 shows a granularity distribution view of the lithium titanate precursor after removing water prepared according to example 1. The particle diameter distribution of the lithium titanate precursor is between 0.15-5.5 um (tested by a laser particle analyzer), the median diameter D₅₀ is about 0.6 um, and the diameter of the lithium titanate particles has a normal distribution.

FIG. 4 shows an XRD view of the lithium titanate composite material M1 tested by the D/MAX-2200/PC X ray powder diffractometer manufactured by Rigaku Company, Japan. Compared with a standard spectrum, with the main peak ((111) peak of about 18 degree) intensity of the spinel lithium titanate oxide being assumed as 1 determined by XRD, the main peak (about 25 degree peak) intensity of rutile-type TiO₂ is lower than 1.0%, and the main peak (about 40 degree peak) intensity of the Li₂TiO₃ is lower than 2.25%.

FIG. 5 shows a SEM view of the lithium titanate prepared by the method thereof measured with SSX-550 SEM equipment manufactured by Shimadzu Company, Japan. From the figure, it may be concluded that the lithium titanate has fine grains and uniform granularity distribution.

FIG. 6 shows a granularity distribution view of lithium titanate prepared by the method according to example 1. The average particle diameter of the lithium titanate is 1.5 um.

### Example 2

The present example relates to the preparation of the lithium titanate composite material according to the present invention.

33.1 g LiNO₃ is dissolved into 60 g deionized water and 14.55 g glucose is added into the formed solution. After the glucose is completely dissolved, rutile-type ultrafine TiO₂ having D₅₀ of 0.4 um and D₉₅ of 0.85 um with weight of 47.9 g is added into the solution slowly under the condition of stirring. The solution is stirred for another 30 minutes and dried under 130° C., and a precursor is obtained after removing water. The precursor is sintered for 16 hours under 900° C. in the N₂ atmosphere and naturally cooled to room temperature to obtain lithium titanate composite material M2 enveloped with carbon. Based on the total amount of the lithium titanate composite material, the carbon content is 9.1 wt %, and the average diameter of the lithium titanate particles is about 1.5 um.

### Example 3

The present example relates to the preparation of the lithium titanate composite material according to the present invention.

49.1 g bi-hydrate lithium acetate is dissolved into 100 g deionized water and 9.7 g ultrafine carbon black (D₉₅ is 0.5 um) is added into the formed solution. Brookite-type ultrafine TiO₂ having D₅₀ of 0.2 um and D₉₅ of 0.85 um with weight of 47.9 g is added into the solution slowly under the condition of stirring. The solution is stirred for another 30 minutes and dried under 130° C., and a precursor is obtained after removing water. The precursor is sintered for 6 hours under 950° C. in the N₂ atmosphere and naturally cooled to room temperature to obtain lithium titanate composite material M3 enveloped with carbon. Based on the total amount of the lithium titanate composite material, the carbon content is 14.2 wt %, and the average diameter of the lithium titanate particles is about 1.2 um.

### Example 4

The present example relates to the preparation of the lithium titanate composite material according to the present invention.

20.1 g LiOH.H₂O is dissolved into 180 g deionized water and 34.7 g liquid nano-graphite having a solid content of 13.8 wt % is added into the formed solution. Anatase-type ultrafine TiO₂ having D₅₀ of 0.35 um and D₉₅ of 0.9 um with a weight of 47.9 g is added into the solution slowly under the condition of stirring. The solution is stirred for another 30 minutes and dried under 150° C., and a precursor is obtained after removing water. The precursor is sintered for 24 hours under 850° C. in the N₂ atmosphere and naturally cooled to room temperature to obtain lithium titanate composite material M4 enveloped with carbon. Based on the total amount of the lithium titanate composite material, the carbon content is 7.6 wt %, and the average particle diameter of the lithium titanate is about 1.8 um.

### Example 5

The present example relates to the preparation of the lithium titanate composite material according to the present invention.

20.1 g LiOH.H₂O is dissolved into 180 g deionized water and 23.1 g saccharose is added into the formed solution. Anatase-type ultrafine TiO₂ having D₅₀ of 0.4 um and D₉₅ of 0.65 um with a weight of 47.9 g is added into the solution slowly under the condition of constant stirring. The solution is stirred for another 30 minutes and dried under 150° C., and a precursor is obtained after removing water. The precursor is sintered for 12 hours under 950° C. in the N₂ atmosphere and naturally cooled to room temperature to obtain lithium titanate composite material M5 enveloped with carbon. Based on the total amount of the lithium titanate composite material, the carbon content is 13.5 wt %, and the average particle diameter of the lithium titanate is about 2.5 um.

### Example 6

The present example relates to the preparation of the lithium titanate composite material according to the present invention.

The lithium titanate composite material is prepared according to the method in example 1, and the only difference lies in that the carbon source is omitted during the preparation. The obtained lithium titanate composite material is noted as M6. The obtained lithium titanate microcrystalline grain has a diameter of 42.6 nm, and the average particle diameter is about 2.6 um.

### Example 7

The present example relates to the preparation of the lithium titanate composite material according to the present invention.

The lithium titanate composite material is prepared according to the method in example 3, and the only difference lies in that the carbon source is omitted during the preparation. The obtained lithium titanate composite material is noted as M7. The obtained lithium titanate microcrystalline grain has a diameter of 36.3 nm, and the average particle diameter is about 1.9 um.

### Comparative Example 1

The present comparative example relates to the preparation of a reference lithium titanate composite material.

20.1 g LiOH.H₂O is dissolved into 180 g deionized water and 23.1 g saccharose is added into the formed solution. Anatase-type ultrafine TiO₂ having D₅₀ of 2 um and D₉₅ of 10 um with a weight of 47.9 g is added slowly into the solution while stirring. The solution is stirred for another 30 minutes and dried under 150° C. and a precursor is obtained after removing water. The precursor is sintered for 12 hours under 850° C. in the N₂ atmosphere and naturally cooled to room temperature to obtain a reference lithium titanate composite material MC1 enveloped with carbon. Based on the total amount of the lithium titanate composite material, the carbon content is 13.8 wt %, and the average diameter of the lithium titanate particles is about 12.9 um.

### Comparative Example 2

The present comparative example relates to the preparation of a reference lithium titanate composite material.

20.1 g LiOH.H₂O, 23.1 g saccharose and 47.9 g ultrafine anatase TiO₂ particles having D₅₀ of 0.4 um and D₉₅ of 0.95 um are added into a ball miller; ethanol is used as the solvent and the mixture in the miller is ball milled for 8 hours and dried under 80° C. to obtain a precursor. The precursor is sintered for 12 hours under 950° C. in the N₂ atmosphere and naturally cooled to room temperature to obtain a reference lithium titanate composite material MC2. Based on the total amount of the lithium titanate composite material, the carbon content is 14.3 wt %, and the average diameter of the lithium titanate particles is about 5.8 um.

### Comparative Example 3

The present comparative example relates to the preparation of a reference lithium titanate composite material.

20.1 g LiOH.H₂O is dissolved into 180 g deionized water and 6.11 g graphite having D₉₅ of 9 um is added into the formed solution. Anatase-type ultrafine TiO₂ having D₅₀ of 0.35 um and D₉₅ of 2 um with a weight of 47.9 g is added slowly into the solution while stirring. The solution is stirred for another 30 minutes and dried under 150° C., and a precursor is obtained after removing water. The precursor is sintered for 24 hours under 850° C. in the N₂ atmosphere and naturally cooled to room temperature to obtain a reference lithium titanate composite material MC3. Based on the total amount of the lithium titanate composite material, the carbon content is 8.85 wt %, and the average diameter of the lithium titanate particles is about 6.5 um.

### Comparative Example 4

The present comparative example relates to the preparation of a reference lithium titanate composite material.

Lithium titanium composite oxide is prepared according to the method disclosed in Chinese Patent CN1893166A. The steps of the method is as follows: 21.6 g LiOH.H₂O is dissolved into 180 g deionized water sufficiently. 47.9 g titanium oxide is added into the solution to adjust the atomic ratio of the lithium to titanium to a designated ratio. The solution is stirred and dried at 120° C., and a precursor is obtained after removing water. The precursor is sintered for 20 hours under 800° C. in the N₂ atmosphere and naturally cooled to room temperature to obtain a lithium titanium composite oxide. The obtained composite oxide is powdered for 3 hours in a ball miller with ZrO₂ particles with average diameter of 3 mm as medium in ethanol. The powder is sintered for another 1 hour and a reference lithium titanate material MC4 is obtained. Based on the total amount of the lithium titanate composite material, the carbon content is 8.9 wt %, and the average particle diameter of the lithium titanate is about 4.2 um.

### Comparative Example 5

The present comparative example relates to the preparation of a reference lithium titanate composite material.

Lithium titanium composite oxide is prepared according to the method disclosed in Chinese Patent CN1893166A. The steps of method are as follows: 21.6 g LiOH.H₂O is dissolved into 180 g deionized water sufficiently. 47.9 g titanium oxide is added into the solution to adjust the atomic ratio of the lithium to titanium to a designated ratio. The solution is stirred and dried under a temperature of 120° C., and the precursor is obtained after removing water. The precursor is sintered for 10 hours under 780° C. in the N₂ atmosphere and naturally cooled to room temperature to obtain a lithium titanium composite oxide. The microcrystalline diameter of the obtained lithium titanate is larger than 62.3 nm, and the average particle diameter thereof is about 9.6 um.

### Examples 8-14

The following examples describe the performance tests of the battery employing the lithium titanate material prepared according to the present invention. It should be noted that the lithium titanate composite material can be used for preparing a negative active substance, which is known in the art. Further, according to an embodiment of the invention, a lithium ion secondary battery may be provided, which may comprise a positive electrode, a negative electrode including the active substance as described hereinabove and a non-aqueous electrolyte. The negative electrode may further include an adhesive and a conducting additive. And the non-aqueous electrolyte may include LiPF₆. According to an embodiment of the present invention, the non-aqueous electrolyte may include at least one organic solvent selected from the group consisting of ethylene carbonate, propylene carbonate, di-ethyl carbonate and di-methyl carbonate.

In the following, the battery employing the lithium titanate material prepared according to the present invention will be described in detail.

1. Preparation of Electrode Plate

80 weight parts of lithium titanate composite material obtained in examples 1-7, 10 weight parts of binder PTFE, 10 weight parts of conductor carbon black are added into 110 weight parts of deionized water and the mixture is stirred to form a stable and uniform negative slurry. After being dried in a vacuum drier for 24 hours under 110° C., the material is pressed to form an electrode plate having a thickness of 0.03 mm and a diameter of 15 mm.

2. Preparation of Battery

LiPF₆, ethylene carbonate and di-methyl carbonate are confected into solution with a concentration of 1 mol/L to serve as the electrolyte.

In the glove box with water content of less than 1 ppm under the protection of Ar atmosphere, the above obtained electrode plate, a lithium plate having a diameter of 15.8 mm and purity of 99.9% serving as the opposite electrode, and Cellgard separator having a diameter of 16 mm are assembled to form a battery core. 0.2 ml electrolyte is added into the core, and CR2016-type button batteries A1-A7 are prepared. After assembly, the batteries are moved out from the glove box and sealed by an electrical puncher.

3. Performance Test

The battery performance tester (Lan Qi BK-6064A) is used to test the batteries. The charge cutoff voltage is 2.5V, the discharge cutoff voltage is 1.0V, and the current density is about 0.15 mA/cm². The initial discharge capacity is tested, and the initial specific capacity is obtained by dividing the initial discharge capacity by the mass of the lithium titanate composite material as shown in table 1.

The above obtained lithium ion secondary batteries A1-A7 are placed separately on the testing cabinet. The charge cutoff voltage is 2.5V, the discharge cutoff voltage is 1.0 V, and the current density is about 0.15 mA/cm² (0.2 C). The initial discharge capacity of the battery is recorded, and the specific discharge capacity and initial charge and discharge efficiency are calculated by the following formula:

Specific discharge capacity=battery initial discharge capacity (mAh)/positive material weight (g);

Initial charge and discharge efficiency=(battery initial discharge capacity/battery initial charge capacity)×100%;

The lithium ion secondary batteries A1-A7 are charged by 0.2 C constant current and constant voltage, and the upper limit of charging is 2.5V. After being laid aside for 20 minutes, the battery is discharged to 1.0V from 2.5V at 5 C current. The battery discharge capacity at each time is recorded and the ratio of each time discharge capacity to the discharge capacity at 0.2 C discharge is calculated respectively, that is:

C_{5C}/C_{0.2C}: this expression designates the ratio of the discharge capacity discharging from 2.5V to 1.0V at 5 C current to that at 0.2 C current.

4. Powder Resistance Test

Total weight of 1000±5 mg lithium titanate material M1-M7 is weighted accurately and is pressed under 500 N pressure. The powder resistance of the material is tested.

The results are shown in table 1.

### Comparative Example 7-12

The comparative examples describe the performance tests of the batteries containing the reference lithium titanate material.

Batteries are prepared according to the method in example 7-14. The difference lies in that, the negative active material is the reference lithium titanate material prepared in the comparative examples 1-5, and the obtained batteries are designated as B1-B5.

The testing results are shown in table 1.

TABLE 1

| | | | | | | Diameter | | Initial | |
|---|---|---|---|---|---|---|---|---|---|
| Serial No. of | | Lithium | Lithium | | | of | Resistance | discharge | C_{5C}/ |
| examples and | Battery | titanate | titanate | TiO₂ | Li₂TiO₃ | microcrys- | of lithium | specific | C_{0.2C} |
| comparative | serial | D₅₀ | D₉₅ | content | content | tallines | titanate | capacity | rate |
| examples | No. | (um) | (um) | (wt %) | (wt %) | (nm) | material (Ω) | (mAh/g) | (%) |
| Example 8 | A1 | 1.53 | 7.5 | 0 | 0.5 | 36.8 | 34 | 172.6 | 96.5 |
| Example 9 | A2 | 1.26 | 7.65 | 0.5 | 0.8 | 40.6 | 236 | 174.5 | 98.7 |
| Example 10 | A3 | 1.18 | 6.34 | 0.9 | 2.0 | 41.9 | 128 | 169.8 | 98.4 |
| Example 11 | A4 | 1.08 | 5.86 | 0.2 | 1.2 | 39.4 | 206 | 172.3 | 99.2 |
| Example 12 | A5 | 1.32 | 7.98 | 0 | 2.25 | 42.8 | 98 | 165.8 | 97.3 |
| Example 13 | A6 | 2.6 | 7.98 | 0.2 | 0.9 | 42.6 | 538 | 173.4 | 81.5 |
| Example 14 | A7 | 1.9 | 6.74 | 0.8 | 1.3 | 36.3 | 385 | 174.6 | 85.8 |
| Comparative | B1 | 5.35 | 23.56 | 3.5 | 5.7 | 48.7 | 2.3 × 10⁶ | 135.8 | 12.8 |
| example 6 | | | | | | | | | |
| Comparative | B2 | 4.36 | 15.38 | 3.2 | 6.3 | 56.9 | 35.6 × 10³ | 140.9 | 28.9 |
| example 7 | | | | | | | | | |
| Comparative | B3 | 3.68 | 13.72 | 4.3 | 8.6 | 50.7 | 68.9 × 10³ | 150.4 | 31.7 |
| example 8 | | | | | | | | | |
| Comparative | B4 | 1.89 | 9.87 | 2.6 | 4.68 | 33.5 | 53.9 × 10³ | 159.4 | 35.4 |
| example 9 | | | | | | | | | |
| Comparative | B5 | 9.6 | 28.6 | 3.4 | 5.1 | 62.3 | 12.3 × 10³ | 162.9 | 36.8 |
| example 10 | | | | | | | | | |

As shown in table 1, the lithium titanate composite material according to the present invention comprises much less impurity phase content than the reference lithium titanate composite material prepared according to the prior art. The batteries A1-A7 prepared from the lithium composite material according to the present invention have better initial discharge specific capacity and rate discharging performance than the batteries B1-B5 employing the reference material according to the comparative examples 1-5. Besides, the preparation method according to the present invention is relatively simple and easy for mass production.

Although explanatory embodiments have been shown and described, it would be appreciated by those skilled in the art that changes, alternatives, and modifications may be made in the embodiments without departing from spirit and principles of the invention. Such changes, alternatives, and modifications all fall into the scope of the claims and their equivalents.

1-17. (canceled)

18. A composite material comprising lithium titanate in a spinel structure, wherein the lithium titanate has a crystallite diameter of about 36 to about 43 nm, and an average particle diameter of about 1 to about 3 μm.

19. The composite material of claim 1, wherein the crystal diameter is about 38 to about 41 nm.

20. The composite material of claim 1, wherein the average particle diameter is about 1.2 to about 1.8 μm.

21. The composite material of claim 1, wherein lithium titanate is about 85 to about 99 wt % of the composite material.

22. The composite material of claim 1, wherein lithium titanate is about 92-97 wt % of the composite material.

23. The composite material of claim 1, further comprising a carbon material.

24. The composite material of claim 23, wherein the carbon material is about 1 to about 15 wt % of the composite material.

25. The composite material of claim 23, wherein the carbon material is about 3 to about 8 wt % of the composite material.

26. A negative electrode active substance comprising the composite material of claim 1.

27. A lithium ion secondary battery comprising:
a non-aqueous electrolyte;
a positive electrode;
a negative electrode;
wherein the negative electrode comprises a negative electrode active substance, comprising a composite material comprising lithium titanate in a spinel structure, and wherein the lithium titanate has a crystallite diameter of about 36 to about 43 nm, and an average particle diameter of about 1 to about 3 μm.

28. The battery of claim 27, wherein the non-aqueous electrolyte comprises LiPF₆.

29. The battery of claim 27, wherein the non-aqueous electrolyte comprises an organic solvent selected from the group consisting of ethylene carbonate, propylene carbonate, di-ethyl carbonate, di-methyl carbonate, and combinations thereof.

30. A method of preparing a composite material comprising:
mixing titanium dioxide particles and a water-soluble lithium source with water to provide a first mixture, wherein the titanium dioxide particles have a D₅₀ value not greater than 0.4 μm and a D₉₅ value less than 1 μm;
removing water to provide a second mixture; and
sintering the mixture in an inert gas under a predetermined constant temperature to provide a composite material.

31. The method of claim 30, wherein the D₅₀ value of the titanium dioxide particles is about 0.1 to about 0.3 μm, and the D₉₅ value of the titanium dioxide particles is about 0.6 to about 0.9 μm.

32. The method of claim 30, wherein the molar ratio of the water-soluble lithium source to the titanium dioxide is about (0.95-1.1):1.25, and the weight ratio of the water-soluble lithium source to water is about 1: (1-15).

33. The method of claim 30, wherein the water-soluble lithium source is selected from lithium hydroxide, lithium acetate, lithium oxalate, lithium nitrate, and combinations thereof.

34. The method of claim 30, wherein the inert gas is selected from the group consisting of carbon oxide, carbon dioxide, N₂, an element of the zero group in the periodic table, and combinations thereof.

35. The method of claim 30, wherein the sintering is carried out at a temperature of about 700 to about 1000° C. for about 5 to 48 hours.

36. The method of claim 30, further comprising:
mixing a carbon source with the first mixture.

37. The method of claim 36, wherein the carbon source is selected from carbohydrate, cellulose-based polymer, polyvinyl alcohol, benzene-naphthalene-phenanthrene terpolymer, benzene-naphthalene biopolymer, benzene-anthracene biopolymer, phenolic resin, furfural resin, artificial graphite, nature graphite, superconducting acetylene black, acetylene black, carbon black, carbonaceous mesophase sphere, and combinations thereof.
